(19) United States
(12) Patent Application Publication
(10) Pub. No.: US 2004/0052393 A1
(43) Pub. Date: Mar. 18, 2004

(54) Clear sound side fill center fill

(76) Inventor: Andrew P. Bronson III, Philadelphia, PA (US)

Correspondence Address: Andrew P. Bronson III, 1956 Pratt St., Philadelphia, PA, 19124, US

(21) Appl. No.: 10/397,336

(22) Filed: Mar. 26, 2003

Related U.S. Application Data
(63) Continuation of application No. 29/167,523, filed on Sep. 16, 2002.

(51) Int. Cl. H04R 1/02; H04R 1/20

(52) U.S. Cl. 381/345; 381/347; 381/386; 381/395

(57) ABSTRACT

A loud speaker enclosure being made in two parts with each of the side panels cut into angle form to assist in angle adjustment, alone with pivot hinges and friction lid supports used to hold it's angled position. The enclosure can be modified to accommodate any design or style of driver boards. In addition to any design of loudspeaker any orientation of enclosing may be incorporated with this invention also. This enclosure can be used with out driver board 5B were by Box B would then operate as a angle adjusting base for Box T.

### CROSS-REFERENCE TO RELATED APPLICATIONS

This is a continuation of application Ser. No. 29/167,523 Filing Date Sep. 16, 2002

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to loudspeaker enclosures, which are used for PA sound reinforcement.

### BACKGROUND OF THE INVENTION

Pro Audio manufacturers and retailers supply sound engineers, musician, stadiums and concert halls with loudspeakers and enclosures to be used during large gatherings to ensure that each member of the audience can hear the event or program they are attending.

Originally these loudspeaker enclosures were made as a straight up right box used to keep the loud speaker from canceling itself out. U.S. Pat. No. 3,862,366 Huszty Etal (1975). However, as times changed and larger crowds gathered, the need for bigger and better looking enclosures grew along with better performance being the key functions.

Thereafter, inventors have attempted to create enclosures that are stylish and attractive looking, but unfortunately looks are a major concern when it comes to the spectators line of sight during a concert event. U.S. Pat. No. 6,122,386 to Wiley (2000) discloses an enclosure that is adjustable and is elevated above the spectators line of sight, but there is still some clutter in the spectators line of sight. For example the poles the enclosures are placed upon and the speaker cables used to feed the signal to the loudspeaker are also in sight. During an event were there is a lot of movement and strong vibration of sound this method could become unstable and possibly endanger spectators and performers. In the case of space on stage being a major concern this enclosure can prove it is not useful, because it takes up a lot of space. U.S. Pat. No. 6,101,261 to Brown, Samuel (2000) discloses an enclosure that is adjustable from an angle point of view. Although this is a great idea, it is limited to operating as an enclosure and only achieves 45-90 degree angles of sound projection. This invention can't be used in all matters of sound reinforcement.

### BACKGROUND OF INVENTION—OBJECTS AND ADVANTAGES

My invention has a number of advantages over the above patents and prior arts.

(a) Operates as a side fill and a center fill enclosure.

(b) The claims of this enclosure can be incorporated into a design for a drum fill or a drum wedge.

(c) Safe and stable method of operation. There is no danger of this enclosure falling over during the event.

(d) Invention does not block spectator view of event.

(e) Easy vertical angle adjustment.

(f) Multiple vertical angle adjustment.

(g) Invention provides the sound of a full size enclosure in a smaller design that dose not require a lot of space.

(h) Any design of driver board can be incorporated.

(i) Box B can also be used as an angle adjustment base utilized by loud speakers being enclosed in box T.

### SUMMARY OF INVENTION

Before explaining several preferred embodiments of the invention in detail, it is to be understood that the invention is not limited in its application, details, construction or to the arrangement of the components that are in the following description and illustrated in the drawings. The invention of this loudspeaker enclosure is capable of other embodiments of PA sound reinforcement.

Those skilled in the art will appreciate the conception, of which this disclosure is based and may be utilized as a basis for designing other structures using the same methods of operation being used by this new invention of a loudspeaker enclosure.

This invention is not designed with any particular size, measurements or angles in mind. But its order of operation remains the same. However depending upon the size and characteristics of the loudspeakers being enclosed, greater angles of sound projection may be achieved, enhancing the abilities of the named invention. This invention can also be incorporated with any style of driver board. With respect to Box B, it can be used as a base used to support Box T in its angle projection of sound Simply by not including any ornamental design on panel 5B.

While working as a sound technician various limitations were noted not just on stage but in front house as well. My invention can be incorporated were overhead tress and catwalks are not available whereby alleviating the need of hanging enclosures above spectators.

The operation of my invention being disclosed in this application can be applied were stadium and concert venue seating arrangements are made on an incline and the stage is in a low position.

### DRAWINGS—FIGURES

FIG. 1 is a perspective view of my new design showing A without panel 5B driver board and B with driver board 5B, Flat Comer Braces and Friction Lid Supports.

FIG. 2 is an exploded view of my new design for a loudspeaker enclosure.

FIG. 3 is a right side view of my new design for a loudspeaker enclosure in its angled position, with Flat Corner Braces and Friction Lid Supports. The left side is a mirror image of this view.

FIG. 4 is a right side view of my new design for a loudspeaker enclosure in an upright position with Flat Corner Braces and Friction Lid Supports. The left side is a mirror image of this view.

FIG. 5 is a rear view of my new design for a loudspeaker enclosure.

The top and bottom panel boards of box T and B have no ornamental design.

### DRAWINGS—REFERENCE NUMERALS

| Bottom box B | Top box T |
|---|---|
| 1B Left Panel board | 1T Left Panel board |
| 2B Right Panel board | 2T Right Panel board |
| 3B Bottom Panel board | 3T Bottom Panel board |
| 4B Top Panel board | 4T Top Panel board |
| 5B Driver board | 5T Driver board |
| 6B Rear Panel board | 6T Rear Panel board |

Hardware Utilized in the Invention.

7BT Friction Lid Support Left and Right side—1,2 Locking Screws

8BT Corner Braces Left and Right side

9T Angle Griping Handle

### DESCRIPTION OF THE PREFERRED EMBODIMENT

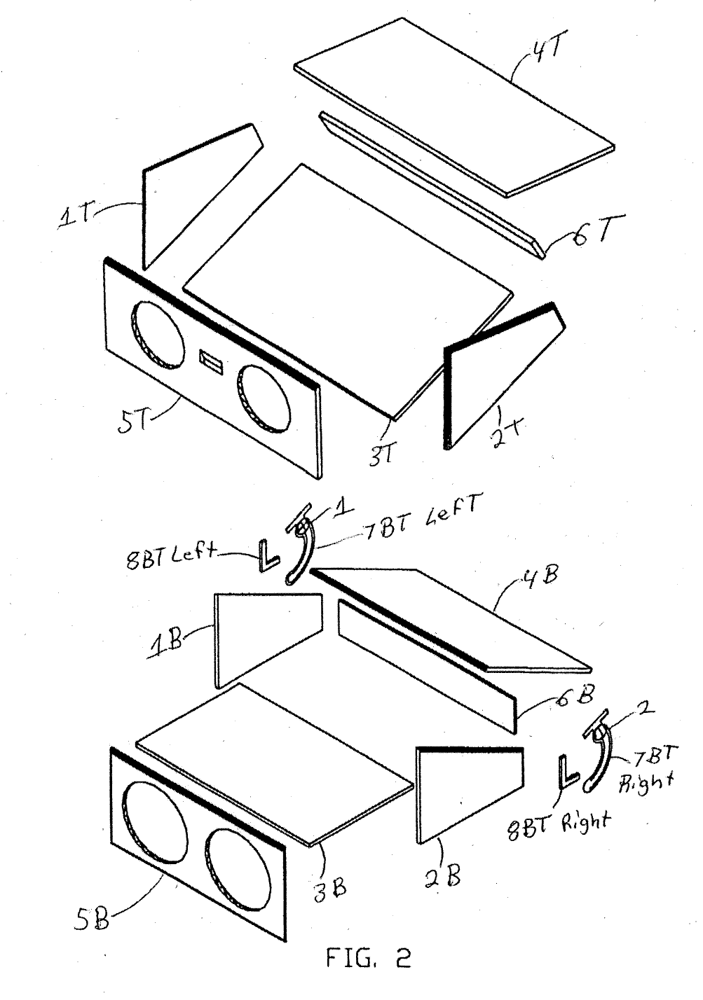

Referring now to the drawings of the FIG. 2 being disclosed. The corresponding parts throughout FIG. 2 are described as follows. FIG. 2 consists of an exploded view exposing all embodiments of the invention.

Referring to the bottom box B starting with panel 3B left edge is joined to the inside low edge of 1B and the right edge of 3B being joined to the inside low edge of 2B. Panel 6B outside left edge is joined to 1B inside rear edge while its right edge is joined to 2B inside rear edge and 6B bottom edge is also joined to 3B inside rear edge, with all edges being lined up evenly.

Panel 4B outside left edge is joined to 1B top inside edge and 2B inside top edge with its rear outside edge joined to 6B top inside edge.

Panel 5B outside edges are joined to the inside front edges of panels 1B, 2B, 3B and 4B completing the assembly of box B.

Referring to the top Box T starting with panel 3T left edge is joined to the inside low edge of 1T and the right edge of 3T being joined to the inside low edge of 2T.

Panel 6T outside left edge is joined to 1T inside rear edge while its right edge is joined to 2T inside rear edge and 6T bottom edge is also joined to 3T inside rear edge, with all edges being lined up evenly.

Panel 4T outside left edge is joined to 1T top inside edge and 2T inside top edge with its rear outside edge joined to 6T top inside edge.

Panel 5T outside edge are joined to the inside front edges of panels 1T, 2T, 3T and 4T completing the assembly of box T.

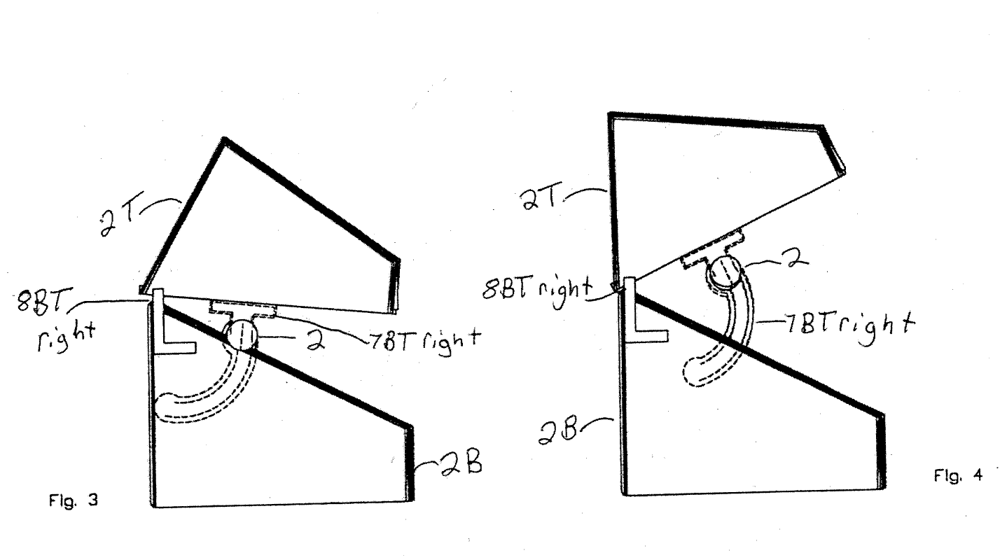

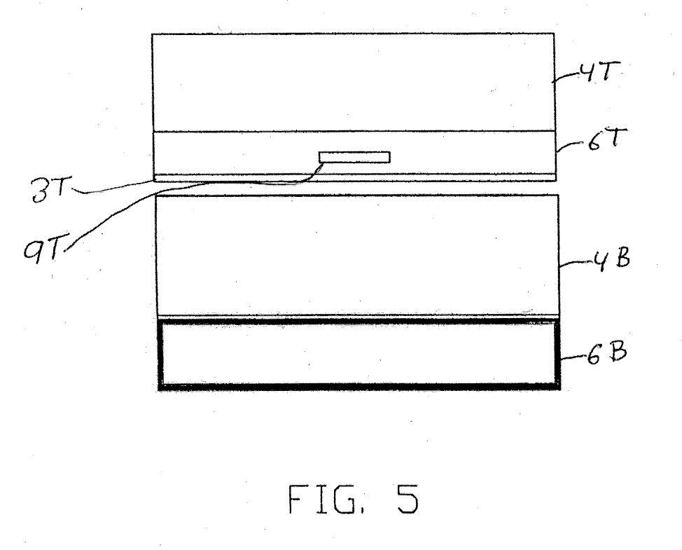

Referring to FIGS. 3 and 4 box B and T are joined together at the far outside edges using Corner Braces 8BT Being placed on the left and right side of the said invention.

Friction Lid Supports are placed of center of FIGS. 3 and 4 to allow for a certain level of angle adjustments.

Referring to FIG. 5 angle gripping handle 9T is attached to the center of the rear panel board 6T this being the rear view of box T and B.

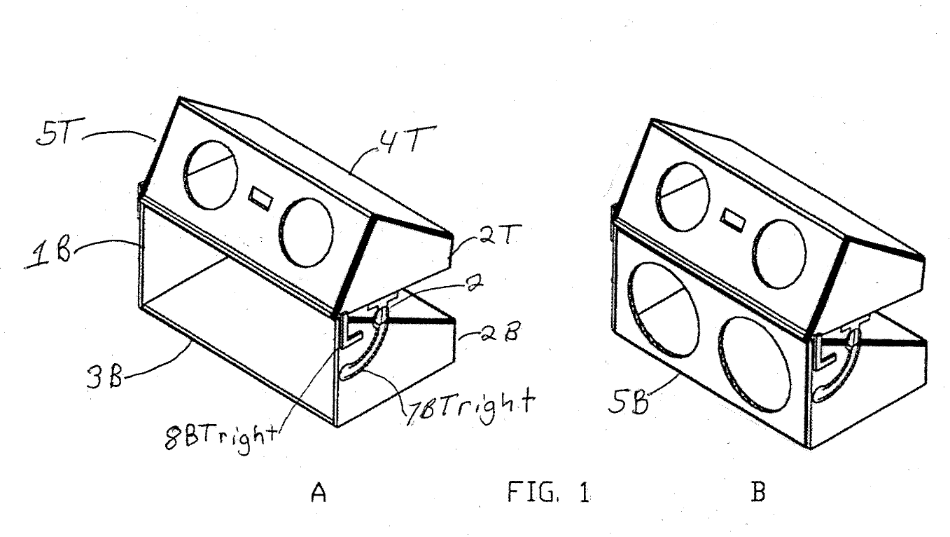

Operational Description of FIGS. 1A-B,3,4 and 5

The manner of which the “Clear Sound Side Fill Center Fill is being used is angle directional adjustment of sound. FIGS. 3,4 shows the right side of the enclosure exposing the corner braces in which the enclosure uses to pivot giving it the ability to make vertical angle adjustments, the left side being the same thereof. This is achieved by grasping the angle griping handle 9T shown in FIG. 5 and by opening the locking screws 1&2, shown in FIGS. 1A-B,3 and 4, that is a part of the Friction Lid Support 7BT being used to support this invention in its application. Raising box T gives the invention a low directional angle of sound and lowering box T gives it a higher directional angle of sound, while box B remain stationary, keeping the invention safe and stable this is shown in FIGS. 1A-B,3 and 4.

Conclusion, Ramifications, and Scope

The invention claimed is new and desired to be secured by Letters Patent:

1. A loudspeaker enclosure that is designed to operate as a side fill and a center fill, comprising in combination, an angle adjustable said loudspeaker enclosure being made in two parts were Box B may be used as an enclosure for sub base and an angle adjusting base for Box T, were Box T can operate as a full range enclosure and a mid and high end enclosure depending upon the said application of box B. The said enclosure pivots using flat corner braces attached to the front corners of the left and right side panels of the said enclosure, the different angles of the said enclosure are held in place by adjustable friction lid supports that are placed in the center of said enclosure with the inside of the curved arms facing front of said enclosure, placing one on the left and the right side of the said enclosure. The top mounting bracket being screwed to the bottom of Box T of the said enclosure and the bottom mounting bracket attached to the sides of Box B of the said enclosure using screws, these function lid supports lock and unlock the rotating angle of the said enclosure by loosening and tightening the screws that are located in the center of the mounting bracket found on the side panels of the Box B of the said enclosure, where by a gripping handle is placed in the center of the rear panel of Box T of the said enclosure to allow for easy controlling while adjusting angles.

2. An article of sound reinforcement comprising the combination of claim 1 for projection of sound at various angles without blocking the spectators line of sight, a said speaker enclosure made of wood material being made with sufficient angles to accommodate use by audio professionals, being for angle adjustment of sound and a free spectators view of sight leaving the lower part of said enclosure stationary.

3. A enclosure for a loud speakers comprising the combination of claim 2 wherein the low portion Box B provides sub bass and an angle-adjusting base of said enclosure with respect to Box T.
